(19) United States
(12) Patent Application Publication
(10) Pub. No.: US 2024/0213463 A1
(43) Pub. Date: Jun. 27, 2024

(54) BATTERY

(71) Applicant: Panasonic Intellectual Property Management Co., Ltd., Osaka (JP)

(72) Inventor: EIICHI KOGA, Hokkaido (JP)

(21) Appl. No.: 18/597,995

(22) Filed: Mar. 7, 2024

Related U.S. Application Data
(63) Continuation of application No. PCT/JP2022/026322, filed on Jun. 30, 2022.

(30) Foreign Application Priority Data
Oct. 6, 2021 (JP) 2021-164858

(51) Int. Cl. H01M 4/48; H01M 10/0525; H01M 10/0562

(52) U.S. Cl. CPC H01M 4/48; H01M 10/0525; H01M 10/0562; H01M 2300/008

(57) ABSTRACT

A battery includes a first active material layer, a solid electrolyte layer, and a second active material layer in this order, at least one selected from the group consisting of the first active material layer and the second active material layer contains metal oxide particles, the solid electrolyte layer contains metal oxide particles, the first active material layer contains a first active material, the second active material layer contains a second active material, and the metal oxide particles have a thermal conductivity higher than that of each of the first active material and the second active material.

### BACKGROUND

### 1. Technical Field

The present disclosure relates to a battery.

### 2. Description of the Related Art

Japanese Unexamined Patent Application Publication No. 2006-185654 has disclosed a solid electrolyte battery including an adhesive layer containing inorganic fine particles between a solid electrolyte layer and an active material layer.

### SUMMARY

One non-limiting and exemplary embodiment provides a battery having an improved reliability.

In one general aspect, the techniques disclosed here feature a battery comprising a first active material layer, a solid electrolyte layer, and a second active material layer in this order. In the battery described above, at least one selected from the group consisting of the first active material layer and the second active material layer contains metal oxide particles, the solid electrolyte layer contains metal oxide particles, the first active material layer contains a first active material, the second active material layer contains a second active material, and the metal oxide particles have a thermal conductivity higher than that of each of the first active material and the second active material.

The present disclosure provides a battery having an improved reliability.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates a cross-sectional view and a plan view showing a schematic structure of a battery 1000 of a first embodiment;

FIG. 2 illustrates a cross-sectional view and a plan view showing a schematic structure of a battery 1100 of a second embodiment;

FIG. 3 illustrates a cross-sectional view and a plan view showing a schematic structure of a battery 1200 of a third embodiment;

FIG. 4 illustrates a cross-sectional view and a plan view showing a schematic structure of a battery 1300 of a fourth embodiment;

FIG. 5 illustrates a cross-sectional view and a plan view showing a schematic structure of a battery 1400 of a fifth embodiment;

FIG. 6 illustrates a cross-sectional view and a plan view showing a schematic structure of a battery 1500 of a sixth embodiment; and

FIG. 7 illustrates a cross-sectional view and a plan view showing a schematic structure of a battery 1600 of a seventh embodiment.

### DETAILED DESCRIPTIONS

### (EMBODIMENTS OF PRESENT DISCLOSURE)

Hereinafter, embodiments of the present disclosure will be described in detail with reference to the drawings.

The following embodiments each show a comprehensive or a concrete example. In the following embodiments, the numerical value, shape, material, constituent element, and arrangement position and connection mode thereof are shown by way of example and are not intended to limit the present disclosure.

In this specification, the term, such as parallel, showing the relationship between elements, the term, such as rectangle, showing the shape of an element, and the range of numerical values indicate not only the strict meanings thereof, but also substantially equivalent scopes thereto including an error of, for example, approximately several percentage points.

The drawings are each a schematic view and are not always required to be strictly drawn. In addition, in the drawings, substantially the same constituent is designated by the same reference numeral, and duplicated description may be omitted or simplified.

In this specification and the drawings, an x axis, a y axis, and a z axis show three axes of a three-dimensional orthogonal coordinate system. In addition, in the embodiments, a z axis direction indicates a thickness direction of a battery. In addition, in this specification, the “thickness direction” indicates a direction vertical to surfaces of layers laminated to each other.

In this specification, “in plan view” indicates the case in which a battery is viewed along a lamination direction of the battery, and the “thickness” in this specification indicates a length of the battery and a length of each layer in the lamination direction.

In this specification, unless otherwise particularly noted, in the battery and the layers forming the battery, a “side surface” indicates a surface of the battery or a surface of each layer forming the battery along the lamination direction described above, and a “main surface” indicates a surface other than the side surface.

In this specification, when the battery is viewed along the lamination direction of the battery, “inside” and “outside” indicate a central side of the battery and an outer peripheral side thereof, respectively.

In this specification, the terms “up” and “down” in the structure of the battery are not used to indicate an upward direction (vertical upward direction) and a downward direction (vertical downward direction), respectively, in the absolute spatial awareness and are used as the terms to be defined by the relative positional relationship based on the lamination order in the lamination structure. In addition, the terms “up” and “down” are used not only in the case in which two constituent elements are disposed with a space therebetween, and another constituent element is present in the space but also in the case in which two constituent elements are disposed in tight contact with each other.

### (First Embodiment)

Hereinafter, a battery of a first embodiment will be described.

The battery of the first embodiment includes a first active material layer, a solid electrolyte layer, and a second active material layer in this order. At least one selected from the group consisting of the first active material layer and the second active material layer contains metal oxide particles. The solid electrolyte layer contains metal oxide particles. The first active material layer contains a first active material. The second active material layer contains a second active material. The metal oxide particles have a thermal conductivity higher than that of each of the first active material and the second active material.

According to the structure described above,heat generated in charge/discharge operation can be diffused from a heat generation position by the metal oxide particles contained in the battery, so that heat dissipation can be performed. As described above, in the battery of the first embodiment, since an increase in temperature of the battery in the operation can be suppressed, battery characteristics can be suppressed from being degraded due to repeated charge/discharge cycles. Accordingly, a highly reliable battery having excellent characteristics can be realized.

As described in the column of “BACKGROUND”, Japanese Unexamined Patent Application Publication No. 2006-185654 has disclosed a solid electrolyte battery including an adhesive layer containing inorganic fine particles between a solid electrolyte layer and an active material layer. The inorganic fine particles described above are disposed only in the adhesive layer located between the active material layer and the solid electrolyte layer. Hence, the battery described above is not configured to diffuse heat generated in the battery to the inside and the outside thereof. That is, the battery described above has no heat dissipation function. Hence, the battery described above has problems, such as degradation in characteristics and reliability, due to the heat generation of the battery.

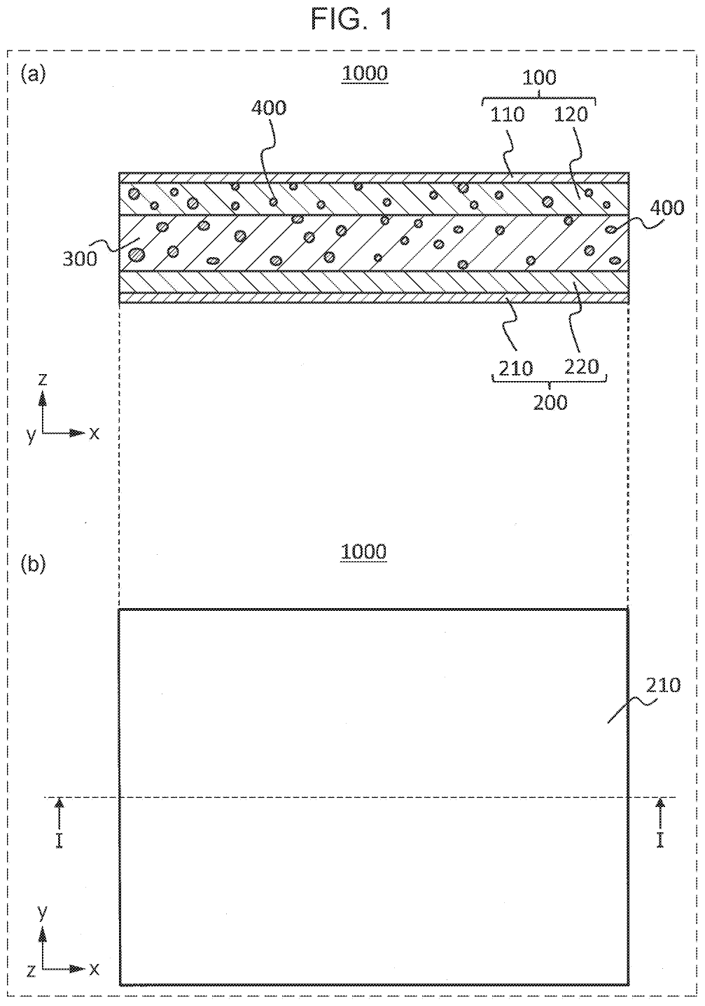

FIG. 1 illustrates a cross-sectional view and a plan view showing a schematic structure of a battery 1000 of the first embodiment.

FIG. 1(a) is a cross-sectional view of the battery 1000 of the first embodiment. FIG. 1(b) is a plan view of the battery 1000 of the first embodiment when viewed from a lower side in the z axis direction. In FIG. 1(a), a cross-section cut along a I-I line of FIG. 1(b) is shown.

As shown in FIG. 1, the battery 1000 includes a first collector 110, a first active material layer 120, a solid electrolyte layer 300, a second active material layer 220, and a second collector 210 in this order. The first active material layer 120 contains a first active material. The second active material layer 220 contains a second active material. The first collector 110 and the first active material layer 120 form a first electrode 100. The second collector 210 and the second active material layer 220 form a second electrode 200.

The solid electrolyte layer 300 contains metal oxide particles 400. The metal oxide particles 400 have a thermal conductivity higher than that of each of the first active material and the second active material.

The battery 1000 is, for example, a solid-state battery.

At least one selected from the group consisting of the first active material layer 120 and the second active material layer 220 may also contain the metal oxide particles 400.

In FIG. 1, the first active material layer 120 and the solid electrolyte layer 300 both contain the metal oxide particles 400.

The first collector 110, the first active material layer 120, the solid electrolyte layer 300, the second active material layer 220, and the second collector 210 each may have an approximately rectangular shape when viewed in plan. The shapes thereof are each not limited to the rectangular shape.

In FIG. 1, the first collector 110, the first active material layer 120, the solid electrolyte layer 300, the second active material layer 220, and the second collector 210 have the same size, and the outlines thereof coincide with each other in plan view; however, the size and the outline are not limited to those described above.

In the plan view, the first active material layer 120 may be smaller than the second active material layer 220.

In the plan view, the first active material layer 120 and the second active material layer 220 may be smaller than the solid electrolyte layer 300.

For example, when the solid electrolyte layer 300 covers at least one of the first active material layer 120 and the second active material layer 220, the solid electrolyte layer 300 may be partially in contact with at least one of the first collector 110 and the second collector 210.

The first electrode 100 may be a positive electrode, and the second electrode 200 may be a negative electrode. In the case described above, the first collector 110 and the first active material layer 120 may be a positive electrode collector and a positive electrode active material layer, respectively. The second collector 210 and the second active material layer 220 are a negative electrode collector and a negative electrode active material layer, respectively. The first active material and the second active material are a positive electrode active material and a negative electrode active material, respectively.

The first electrode 100 may be a negative electrode, and the second electrode 200 may be a positive electrode. In particular, the first collector 110 may be a negative electrode collector, the first active material layer 120 may be a negative electrode active material layer, and the first active material may be a negative electrode active material. The second collector 210 may be a positive electrode collector, the second active material layer 220 may be a positive electrode active material layer, and the second active material may be a positive electrode active material.

Hereinafter, the positive electrode active material layer and the negative electrode active material layer are collectively called “active material layer” in some cases. The positive electrode active material and the negative electrode active material are collectively called “active material” in some cases. The positive electrode collector and the negative electrode collector are collectively called “collector” in some cases.

The collector may be formed from a material having an electric conductivity. The material described above is, for example, stainless steel, nickel (Ni), aluminum (Al), iron

(Fe), titanium (Ti), copper (Cu), palladium (Pd), gold (Au), platinum (Pt), or an alloy containing at least two of those mentioned above.

The collector may have a foil, a plate, or a net shape.

A material of the collector may be selected in consideration of a manufacturing process, a use temperature, a use pressure, a battery operation potential applied on the collector, and/or the electric conductivity. In addition, the material of the collector may also be selected in consideration of the tensile strength and heat resistance required for the battery. The collector may be formed, for example, from high-strength electrolytic copper foil or a clad material in which different types of metal foil are laminated to each other.

The collector may have a thickness, for example, of greater than or equal to 10 μm and less than or equal to 100 μm.

In order to improve the adhesion to the active material layer (that is, the first active material layer 120 or the second active material layer 220), the collector may be treated to have an irregular rough surface. Accordingly, for example, a bonding property at the interface between the collector and the active material layer is enhanced, and the mechanical and thermal reliability and the cycle characteristics of the battery 1000 are improved. In addition, since the contact area between the collector and the active material layer is increased, the electric resistance is decreased.

The first active material layer 120 may be in contact with the first collector 110. The first active material layer 120 may cover the entire main surface of the first collector 110.

The positive electrode active material layer contains a positive electrode active material.

At a higher potential than that of the negative electrode, metal ions of lithium (Li), magnesium (Mg), or the like are inserted in or released from the crystalline structure of the positive electrode active material, and in conjunction therewith, the material described above is oxidized or reduced.

The positive electrode active material is, for example, a compound containing lithium and a transition metal element.

The compound described above is, for example, an oxide containing lithium and a transition metal element or a phosphoric acid compound containing lithium and a transition metal element.

As the oxide containing lithium and a transition metal element, for example, there may be mentioned a lithium nickel composite oxide, such as LiNiₓM₁₋ₓO₂ (M represents at least one selected from the group consisting of Co, Al, Mn, V, Cr, Mg, Ca, Ti, Zr, Nb, Mo, and W, and 0<x≤1 holds); a layered oxide, such as lithium cobalt oxide (LiCoO₂) or lithium nickel oxide (LiNiO₂); or lithium manganese oxide (such as LiMn₂O₄, Li₂MnO₃, or LiMnO₂) having a spinel structure.

As the phosphoric acid compound containing lithium and a transition metal element, for example, lithium iron phosphate (LiFePO₄) having an olivine structure may be mentioned.

As the positive electrode active material, sulfur (S) or a sulfide, such as lithium sulfide (Li₂S), may be used. In the case described above, for example, lithium niobe oxide (LiNbO₃) may be coated on or added to positive electrode active material particles.

As the positive electrode active material, those materials mentioned above may be used alone, or at least two types thereof may be used in combination.

In order to improve the lithium ion conductivity and the electron conductivity, the positive electrode active material layer may also contain, besides the positive electrode active material, a material other than the positive electrode active material. That is, the positive electrode active material layer may be a mixture layer. As the material described above, for example, there may be mentioned a solid electrolyte, such as an inorganic-based solid electrolyte or a sulfide-based solid electrolyte, an electric conductive auxiliary agent such acetylene black, and/or a binding material, such as a polyethylene oxide or a polyvinylidene fluoride.

The positive electrode active material layer may have a thickness of, for example, greater than or equal to 5 μm and less than or equal to 100 μm.

The solid electrolyte layer 300 and the second active material layer 220 may contain the metal oxide particles 400. In the case described above, the first active material layer 120 may or may not contain the metal oxide particles 400.

The first active material layer 120, the solid electrolyte layer 300, and the second active material layer 220 may contain the metal oxide particles 400.

The metal oxide particles 400 may include at least one selected from the group consisting of first metal oxide particles located at a first interface between the solid electrolyte layer 300 and the first active material layer 120 and second metal oxide particles located at a second interface between the solid electrolyte layer 300 and the second active material layer 220. Accordingly, the heat can be diffused between the layers through the interfaces provided therebetween. As a result, local heat generation can be suppressed. Hence, the battery characteristics and the battery life can be suppressed from being degraded.

The metal oxide particles 400 may include the first metal oxide particles and the second metal oxide particles. Accordingly, heat generated locally in the battery passes across the two interfaces which are liable to inhibit the thermal conductivity. Since being able to be diffused to the other layers through the two interfaces, the heat thus generated is more likely to be diffused. As a result, an increase in temperature of the battery can be suppressed. Hence, the battery characteristics can be suppressed from being degraded due to repeated charge/discharge cycles.

The metal oxide particles 400 may be in contact with the side surface of the solid electrolyte layer 300 from the inside thereof.

The metal oxide particles 400 are not only contained inside the solid electrolyte layer 300 but also may be adhered to the side surfaces of the solid electrolyte layer 300, the first active material layer 120, and the second active material layer 220 from the outsides thereof. Accordingly, a short circuit caused by adhesion of foreign substances to the side surface of the battery and/or falling of the active material can be suppressed. In addition, since an outer peripheral portion at which interlayer peeling is liable to occur is fixed by an anchor effect of the metal oxide particles, the structural defect can also be suppressed. The metal oxide particles 400 may be adhered to the side surface of the solid electrolyte layer 300 from the outside thereof.

The metal oxide particles 400 may include particles having a particle diameter of greater than or equal to 1 μm and less than or equal to 100 μm.

The metal oxide particles 400 may include particles having a particle diameter larger than the thickness of each of the solid electrolyte layer 300, the first active material layer 120, and the second active material layer 220. In the case described above, the metal oxide particles 400 having the particle diameter described above are to be disposed across at least two layers. Accordingly, the heat generated locally is diffused to a plurality of layers across the interface therebetween. As described above, since the transportation and the diffusion of heat are promoted, a local increase in temperature of the battery is suppressed. In addition, since the metal oxide particles 400 each function as an anchor to strongly bind the layers together, the interlayer peeling caused by a thermal shock or the like can be suppressed, and the structural defect is not likely to occur.

The metal oxide particles 400 may include particles having a particle diameter of greater than or equal to 1 μm and less than or equal to 10 μm. Accordingly, in the inside of each of the layers (that is, the solid electrolyte layer 300, the first active material layer 120, and the second active material layer 220), the metal oxide particles 400 can be disposed. As a result, in particular, the diffusion of the heat in the layer can be effectively promoted.

In addition, the inside of the layer also includes a bonding interface to the adjacent layer. In addition, since the particle diameter described above is smaller than the thickness (such as 10 μm) of a general collector, the metal oxide particle 400 is not allowed to penetrate therethrough, and hence, the collector can be prevented from being broken.

The particle diameterof the metal oxide particles 400 is defined by the length of the longest axis of the particle.

The cross-sectional shape of the metal oxide particle 400 may be approximately circular. As other examples of the shape, an oval shape or a scale shape may be mentioned. Since the specific surface area of the particle is increased as the shape thereof is decreased, a bonding area to a different material (such as the active material or the solid electrolyte) is increased. Hence, the area of a heat dissipation path is increased, and as a result, the heat dissipation characteristics are improved. In addition, a bonding property to the different material (such as the active material or the solid electrolyte) is also improved, and hence, the number of structural defects can be reduced.

The metal oxide particles 400 may also be located in voids between particles of the solid electrolyte and the active material.

The metal oxide particles 400 may be in contact with the surfaces of solid electrolyte particles. That is, the solid electrolyte layer 300 contains the solid electrolyte particles, and the metal oxide particles 400 may be in contact with the surfaces of the solid electrolyte particles. In addition, the metal oxide particles 400 may be in contact with the surfaces of clusters (that is, aggregates) each formed of the solid electrolyte particles.

The metal oxide particles 400 may be in contact with the surfaces of active material particles. That is, besides the solid electrolyte layer 300, at least one selected from the group consisting of the first active material layer 120 and the second active material layer 220 also contains the metal oxide particles 400, the active material layer described above contains active material particles, and the metal oxide particles 400 may be in contact with the surfaces of the active material particles. In addition, the metal oxide particles 400 may be in contact with the surfaces of clusters (that is, aggregates) each formed of the active material particles. Accordingly, the heat dissipation is likely to occur from the surfaces of the clusters of the active material particles which generate heat. The metal oxide particles 400 may be not in contact with the surfaces of the active material particles.

As described above, since the metal oxide particles 400 are disposed at positions at which the solid electrolyte layer 300, the first active material layer 120, and the second active material layer 220 are liable to generate heat, the heat dissipation can be selectively promoted, and hence, the heat can be efficiently dissipated. Accordingly, the characteristics of the battery can be suppressed from being degraded due to the heat generation therefrom.

The metal oxide particles 400 may be dispersed in the solid electrolyte layer 300. Since the metal oxide particles 400 are dispersed in the solid electrolyte layer 300, the heat is efficiently diffused, and hence, the characteristics of the battery can be further suppressed from being degraded due to the heat generation therefrom.

When the first active material layer 120 contains the metal oxide particles 400, the metal oxide particles 400 may be dispersed in the first active material layer 120. When the second active material layer 220 contains the metal oxide particles 400, the metal oxide particles 400 may be dispersed in the second active material layer 220.

When the first active material layer 120 contains the metal oxide particles 400, the metal oxide particles 400 may include third metal oxide particles located at a third interface between the first active material layer 120 and the first collector 110. When the second active material layer 220 contains the metal oxide particles 400, the metal oxide particles 400 may include fourth metal oxide particles located at a fourth interface between the second active material layer 220 and the second collector 210.

The metal oxide particles 400 may be uniformly dispersed in the first active material layer 120, the solid electrolyte layer 300, and the second active material layer 220.

A volume rate of the metal oxide particles 400 in the solid electrolyte layer 300 may be higher than that of the metal oxide particles 400 in the first active material layer 120 or the second active material layer 220. Accordingly, the heat generated in the first active material layer 120 and the heat generated in the second active material layer 220 are likely to be diffused in the solid electrolyte layer 300. Hence, the local heat generation in the battery can be suppressed.

When the first active material layer 120 and the second active material layer 220 contain the metal oxide particles 400, the volume rate of the metal oxide particles 400 in the first active material layer 120 may be higher than that of the metal oxide particles 400 in the second active material layer 220. Accordingly, an active material layer which is liable to generate heat or an active material layer having characteristics liable to be degraded by heat can be selectively improved in heat dissipation. As described above, while the influence on the characteristics of the battery is reduced, the reliability thereof can be improved.

The solid electrolyte layer 300 may contain greater than or equal to 3 percent by volume and less than or equal to 30 percent by volume of the metal oxide particles 400.

The volume rate of the metal oxide particles 400 is obtained in a manner such that an area rate of the metal oxide particles 400 in the solid electrolyte layer 300, the first active material layer 120, or the second active material layer 220 is measured by a cross-sectional observation using a scanning electron microscopic (SEM) image, and the value thus obtained is regarded as the volume rate. The cross-section used in the cross-sectional observation is, for example, an ion polished surface.

The first active material layer 120 may contain greater than or equal to 1 percent by volume and less than or equal to 10 percent by volume of the metal oxide particles 400.

In order to improve the heat dissipation, the metal oxide particles 400 may have a high thermal conductivity. For example, the thermal conductivity of the metal oxide particles 400 may be higher than or equal to 10 W/(m⋅K) at 25° C. An upper limit of the thermal conductivity of the metal oxide particles 400 is not particularly limited, and for example, the thermal conductivity described above may be lower than or equal to 200 W/(m⋅K) at 25° C.

The metal oxide particles 400 may have an insulation property. Accordingly, even when the metal oxide particles 400 are disposed at an arbitrary position in the battery, charge/discharge characteristics are not adversely influenced (for example, without causing a short circuit), and the heat dissipation effect can be realized. Hence, in accordance with the design and/or the structure of the battery, the metal oxide particles 400 can be flexibly and selectively disposed, for example, at a position at which heat generation is liable to occur, and/or at a position at which the heat dissipation is low.

The metal oxide particles 400 may contain at least one selected from the group consisting of Y, Al, and Mg. Accordingly, the metal oxide particles 400 have a high thermal conductivity.

As the material of the metal oxide particles 400, for example, there may be mentioned yttrium oxide (thermal conductivity: 27 W/(m·K)), aluminum oxide (thermal conductivity: 30 W/(m⋅K)), or magnesium oxide (thermal conductivity: 60 W/(m⋅K)).

The metal oxide particles 400 have a thermal conductivity higher than that of a general positive electrode material such as LiCoO₂ (thermal conductivity: approximately less than 10 W/(m·K)).

The metal oxide particles 400 may contain Y. The metal oxide particles 400 may contain yttrium oxide and may also be yttrium oxide itself.

Yttrium oxide has a specific gravity of approximately 5.0 g/cm³. The specific gravity described above is higher than that of aluminum oxide (3.6 g/cm³) and that of magnesium oxide (3.4 g/cm³). Hence, when yttrium oxide is contained as the metal oxide particles 400, without increasing the volume of the battery, the heat dissipation characteristics can be imparted thereto. That is, while the volume energy density of the battery is not decreased, the characteristics of the battery can be suppressed from being degraded due to the heat generation therefrom.

Yttrium oxide has a Young's modulus of approximately 170 GPa. The Young's modulus described above is lower than that of aluminum oxide and that of magnesium oxide, and hence, yttrium oxide is excellent in deformability. In addition, aluminum oxide has a Young's modulus of greater than or equal to 300 GPA and less than or equal to 400

GPa, and magnesium oxide has a Young's modulus of approximately 320 GPa. As a result, yttrium oxide is excellent in bonding property and adhesion to another material (such as the active material). Hence, the number of structural defects caused by a heat cycle and/or a stress, such as bending, can be reduced. In addition, since a heat transport loss at the interface is small, the heat dissipation can be improved.

The metal oxide particles 400 are an oxide containing Y (such as yttrium oxide) and may have an oxygen deficiency.

The oxygen deficiency of Y₂O₃ can be formed, for example, in a manner such that in a reducing atmosphere (such as in a mixture gas containing nitrogen and hydrogen), Y₂O₃ is heat-treated at higher than or equal to 700° C. and lower than or equal to 1,300° C. for longer than or equal to 1 hour and shorter than or equal to 10 hours. In the case described above, oxygen is slightly released from white Y₂O₃, and black-colored Y₂O_{3-δ} is obtained.

According to the structure described above, while the thermal conductivity and the deformability of Y₂O₃ are obtained, laser processability (such as energy absorption) can be improved, and/or color tone (black coloration) more responding to image recognition can also be obtained. Hence, the processability and the accuracy of the battery can be improved. As described above, a highly reliable battery having an excellent processability can be realized.

The metal oxide particles 400 may be harder than the first collector 110, the solid electrolyte contained in the solid electrolyte layer 300, and the second collector 210.

Accordingly, since the metal oxide particles 400 are allowed to enter the layers and are then tightly fixed thereto, the anchor effect can be increased, and hence, the layers are tightly bonded to each other. As a result, the structural defect, such as the interlayer peeling, can be suppressed from being generated by a thermal shock, such as a heat cycle. The metal oxide particles 400 may also be harder than the first active material and the second active material.

The hardnesses of the metal oxide particles 400, the first collector 110, the solid electrolyte, and the second collector 210 can be evaluated by a method similar to that of the Vickers hardness. For example, the hardnesses can be compared to each other in a manner such that a rigid indenter is pushed to a predetermined position of a test sample with the same load, and the deformation formed thereby is measured for comparison. When the evaluation is performed on a finely small area of each layer as described above, the hardnesses of the metal oxide particles 400, the first collector 110, the solid electrolyte, and the second collector 210 can be compared to each other. The Vickers hardness of a finely small area can be measured, for example, using a commercial apparatus. As the commercial apparatus, for example, a Microvickers Hardness tester manufactured by a Mitsutoyo Corporation may be mentioned.

In addition, since silicon nitride and silicon carbide also have a high thermal conductivity, as is the case of the metal oxide particles 400, the effect to improve the heat dissipation of the battery can be obtained. However, since silicon nitride and silicon carbide both have a relatively small coefficient of thermal expansion as compared to that of each of the oxide and the metal (collector), voids are liable to be generated at interfaces between the materials forming the layers by a heat cycle, and in particular, voids are liable to be generated at the interface with the positive electrode active material. In addition, the coefficients of thermal expansion of silicon nitride and silicon carbide are greater than or equal to 50% and less than or equal to 70% of that of yttrium oxide.

As the metal oxide particles 400, at least two types of metal oxides may be used. For example, the metal oxide particles 400 may include yttrium oxide and magnesium oxide. In consideration of the thermal conductivity and the mechanical characteristics, the contents of the at least two types of metal oxides may be adjusted.

The composition, the content, the dispersion state, and the particle diameter of the metal oxide particles 400 can be analyzed in a manner such that a composition analysis (such as a point analysis or an area analysis) is performed using an electron probe micro analyzer (EPMA) or an energy dispersive X-ray spectroscopic analysis (EDS) on a polished cross-section of a battery 1000 processed by an ion polisher or the like. Accordingly, since the composition of the metal oxide particles 400 is confirmed, the thermal conductivity of the metal oxide particles 400 may be compared to that of the active material, for example, using literature data.

In the case in which the metal oxide particles 400 are also contained in the active material layer, for example, the thermal conductivity of a surface of the active material layer polished by an ion polisher or mechanical polishing is measured by a laser flash method, and the same measurement as described above is also performed on an active material layer having a different content of the metal oxide particles 400 to confirm the change in thermal conductivity caused by the difference in content of the metal oxide particles 400, so that the magnitude relationship between the thermal conductivity of the metal oxide particles 400 and that of the active material contained in the active material layer may be evaluated. When the metal oxide particles 400 contained in the solid electrolyte layer 300 and the metal oxide particles 400 contained in the active material layer are particles formed from the same material, that is, when the particles contained in the solid electrolyte layer 300 and the particles contained in the active material layer have the same thermal conductivity, by the method described above, the magnitude relationship between the thermal conductivity of the metal oxide particles 400 in the solid electrolyte layer 300 and that of the active material can also be confirmed.

Although being able to be recognized from the color tone by visual inspection or a metallographic microscope, the oxygen deficiency (black color) of yttrium oxide can also be evaluated using a color-difference meter. In addition, the bonding state with oxygen may also be evaluated using an X-ray photoelectron spectroscopic method (XPS).

The second active material layer 220 may be in contact with the second collector 210. The second active material layer 220 may cover the entire main surface of the second collector 210.

The negative electrode active material layer contains a negative electrode active material.

At a lower potential than that of the positive electrode, metal ions of lithium (Li), magnesium (Mg), or the like are inserted in or released from the crystalline structure of the negative electrode active material, and in conjunction therewith, the material described above is oxidized or reduced.

As the negative electrode active material, for example, there may be mentioned a carbon material, such as natural graphite, artificial graphite, graphite carbon fibers, or resin heat-treated carbon, or an alloy-based material to be mixed with a solid electrolyte. As the alloy-based material, for example, there may be mentioned a lithium alloy, such as LiAl,

Lizn, Li₃Bi, Li₃Cd, Li₃Sb, Li₄Si, Li_{4.4}Pb, Li_{4.4}Sn, Li_{0.17}C, or LiC₆; an oxide, such as lithium titanium oxide (Li₄Ti₅O₁₂), containing lithium and a transition metal element; or a metal oxide, such as zinc oxide (ZnO) or silicon oxide (SiOₓ).

For the negative electrode active material, the materials mentioned above may be used alone, or at least two types thereof may be used in combination.

In order to improve the lithium ion conductivity and the electron conductivity, in the negative electrode active material layer, besides the negative electrode active material, a material other than the negative electrode active material may also be contained. As the material described above, for example, there may be mentioned a solid electrolyte, such as an inorganic-based solid electrolyte or a sulfide-based solid electrolyte, an electric conductive auxiliary agent such as acetylene black, and/or a binding material, such as a polyethylene oxide or a polyvinylidene fluoride.

The negative electrode active material layer may have a thickness of, for example, greater than or equal to 5 μm and less than or equal to 100 μm.

The solid electrolyte layer 300 contains a solid electrolyte. The solid electrolyte layer 300 contains the solid electrolyte, for example, as a primary component. In the case described above, the primary component indicates a component, the mass rate of which in the solid electrolyte layer 300 is highest. The solid electrolyte layer 300 may be formed only from a solid electrolyte.

The solid electrolyte may be a known solid electrolyte used for battery having an ion conductivity. As the solid electrolyte, for example, a solid electrolyte to conduct metal ions, such as lithium ions or magnesium ions, may be used.

As the solid electrolyte, for example, a sulfide-based solid electrolyte, an oxide-based solid electrolyte, or a halide solid electrolyte may be used.

The solid electrolyte layer 300 may contain a halide solid electrolyte.

As the sulfide-based solid electrolyte, for example, there may be mentioned a Li₂S-P₂S₅-based, a Li₂S-SiS₂-based, a Li₂S-B₂S₃-based, a Li₂S-GeS₂-based, a Li₂S-SiS₂-LiI-based, a Li₂S-SiS₂-Li₃PO₄- based, a Li₂S-Ge₂S₂-based, a Li₂S-GeS₂-P₂S₅-based, or a Li₂S-GeS₂-ZnS-based solid electrolyte.

As the oxide-based solid electrolyte, for example, there may be mentioned a lithium-containing metal oxide, a lithium-containing metal nitride, lithium phosphate (Li₃PO₄), or a lithium-containing transition metal oxide. As the lithium-containing metal oxide, for example, Li₂O—SiO₂ or Li₂O—SiO₂—P₂O₅ may be mentioned. As the lithium-containing metal nitride, for example, LiₓP_{y}O_{1-z}N_{z} (0<z≤1) may be mentioned. In addition, as the lithium-containing transition metal oxide, for example, lithium titanium oxide may be mentioned.

As the halide solid electrolyte, for example, a compound including Li, M, and X may be mentioned. In the case described above, M represents at least one selected from the group consisting of metal elements other than Li and metalloid elements. In addition, X represents at least one selected from the group consisting of F, Cl, Br, and I.

The “metalloid element” includes B, Si, Ge, As, Sb, and Te. The “metal element” includes all elements (except for hydrogen) from group I to group XII in the periodic table and all elements (except for B, Si, Ge, As, Sb, Te, C, N, P, O, S, and Se) from group XIII to group XVI in the periodic table.

In order to improve the ion conductivity of the halide solid electrolyte, M may include Y. M may be Y itself.

The halide solid electrolyte may be, for example, a compound represented by LiₐMe_{b}Y_{c}X6. In the case described above, a+mb+3c=6 and c>0 are satisfied. The value of m represents the valency of Me.

In order to improve the ion conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

In order to improve the ion conductivity of the halide solid electrolyte, X may include at least one selected from the group consisting of Cl and Br.

The halide solid electrolyte may contain, for example, at least one selected from the group consisting of Li₃YCl₆ and Li₃YBr₆.

In addition, as the solid electrolyte, the materials mentioned above may be used alone, or at least two types thereof may be used in combination.

When the metal oxide particles 400 contain Y₂O₃, and as the solid electrolyte, a sulfide-based solid electrolyte is used, by heat application in a manufacturing process, and/or by a mechanochemical effect obtained by contact between Y₂O₃ and the sulfide-based solid electrolyte in a dispersion step, yttrium sulfide may be formed in some cases.

In order to prevent the formation described above, when the metal oxide particles 400 contain Y₂O₃, as the solid electrolyte, a halide solid electrolyte may be used.

The solid electrolyte and the metal oxide particles 400 may contain the same metal element.

The solid electrolyte layer 300 may also contain, besides the solid electrolyte described above, a binding material, such as a polyethylene oxide or a polyvinylidene fluoride.

The solid electrolyte layer 300 may have a thickness, for example, of greater than or equal to 10 μm and less than or equal to 100 μm.

The material of the solid electrolyte may be formed of aggregates of particles.

Alternatively, the material of the solid electrolyte may be formed of a sintered structure.

(Second Embodiment)

Hereinafter, a battery of a second embodiment will be described. The items described in the first embodiment may be appropriately omitted.

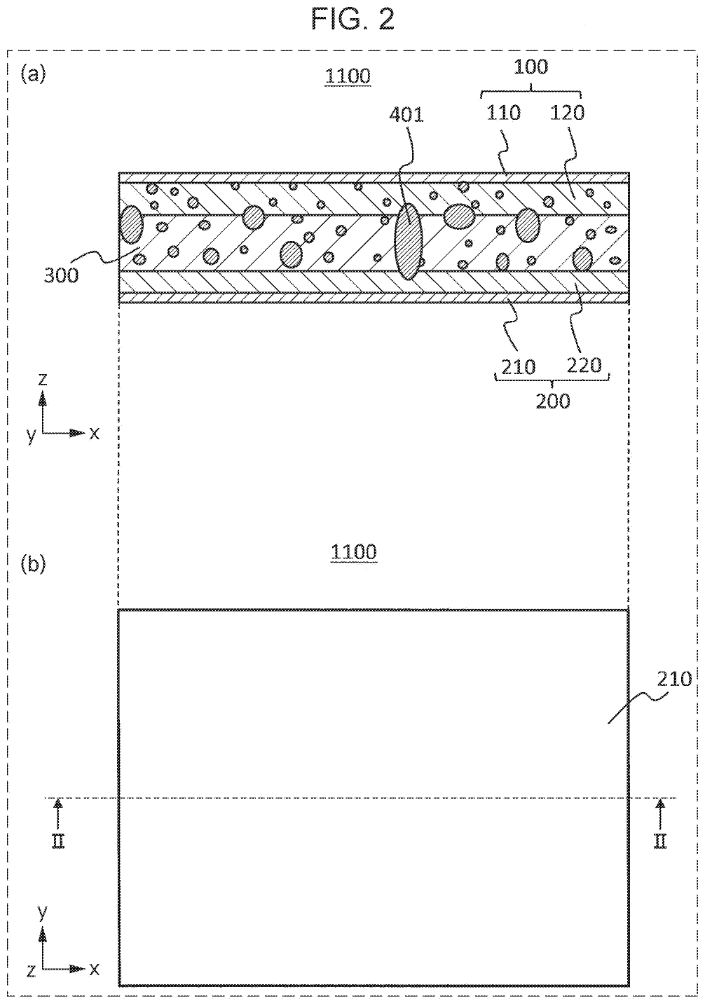

FIG. 2 illustrates a cross-sectional view and a plan view showing a schematic structure of a battery 1100 of the second embodiment.

FIG. 2(a) is a cross-sectional view of the battery 1100 of the second embodiment. FIG. 2(b) is a plan view of the battery 1100 of the second embodiment when viewed from a lower side along the z axis direction. FIG. 2(a) shows a cross-section cut along II-II line in FIG. 2(b).

As shown in FIG. 2, the battery 1100 contains metal oxide particles 401. The metal oxide particles 401 have a large particle diameter. The particle diameter of the metal oxide particles 401 is larger, for example, than the thickness of at least one selected from the group consisting of the first active material layer 120, the solid electrolyte layer 300, and the second active material layer 220. Except for that described above, the metal oxide particles 401 are the same as the metal oxide particles 400 described in the first embodiment.

The particle diameter of the metal oxide particles 401 is, for example, greater than or equal to 10 μm and less than or equal to 100 μm.

According to the structure described above, the metal oxide particles 401 may be disposed across the interface between the layers. Hence, when being generated locally, heat passes across each interface between the layers through the metal oxide particles 401 and is likely to be diffused. As a result, an increase in temperature of the battery can be suppressed. In addition, the metal oxide particles can obtain an anchor effect to strongly bind the layers together. As a result, even when a thermal shock and/or a stress, such as bending, is applied to the battery, the interlayer peeling can be suppressed from being generated. As described above, since the local heat generation is suppressed, and the interlayer peeling is difficult to occur, a highly reliable battery can be realized.

The battery 1100 May contain, besides the metal oxide particles 401, metal oxide particles having a small particle diameter. The particle diameter of the metal oxide particles described above is, for example, greater than or equal to 1 μm and less than or equal to 10 μm.

The particle diameter of the metal oxide particles 401 may be larger than the thickness of the solid electrolyte layer 300.

As shown in FIG. 2, in the battery 1100, the metal oxide particles 401 may include metal oxide particles located continuously in the first active material layer 120, the solid electrolyte layer 300, and the second active material layer 220.

In the total metal oxide particles contained in the battery, the content of the metal oxide particles 401 may be approximately greater than or equal to 30 percent by volume.

In the case described above, the content of the remaining metal oxide particles having a small particle diameter is less than or equal to 70 percent by volume.

The metal oxide particle 401 is not required to have a spherical shape, and as an example other than the spherical shape, an oval shape or a scale shape may be mentioned.

The particle diameter indicates the longest portion of the particle. (Third Embodiment)

Hereinafter, a battery of a third embodiment will be described. The items described in the above embodiments may be appropriately omitted.

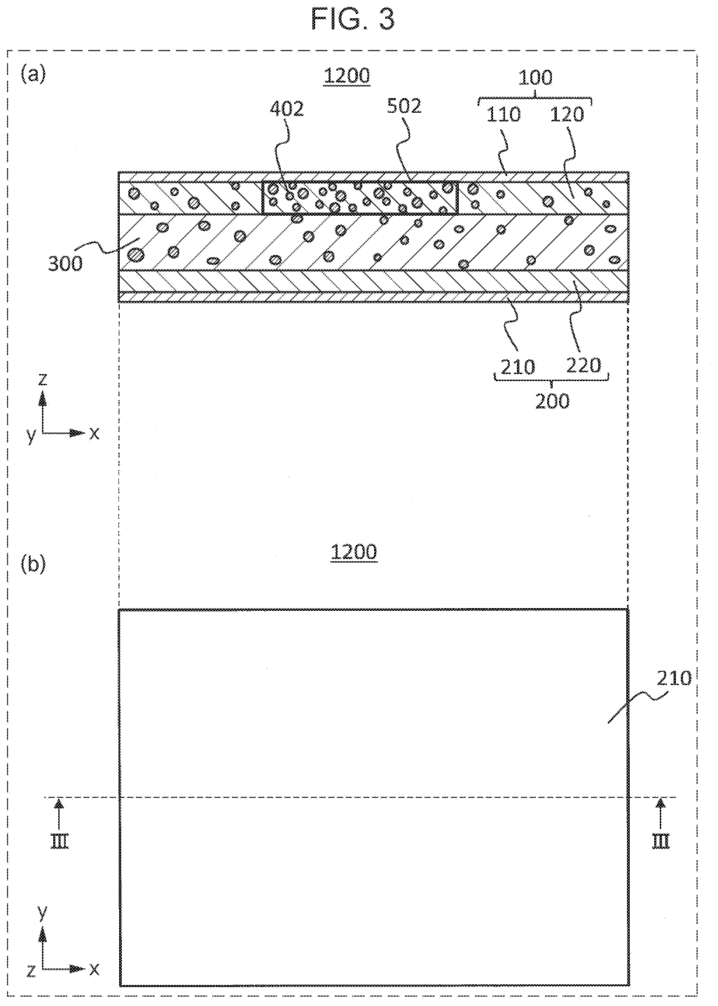

FIG. 3 illustrates a cross-sectional view and a plan view showing a schematic structure of a battery 1200 of the third embodiment.

FIG. 3(a) is a cross-sectional view of the battery 1200 of the third embodiment. FIG. 3(b) is a plan view of the battery 1200 of the third embodiment when viewed from a lower side along the z axis direction. FIG. 3(a) shows a cross-section cut along a III-III line in FIG. 3(b).

As shown in FIG. 3, in the battery 1200, the first active material layer 120 encloses metal oxide particles 402. In the plan view, the metal oxide particles 402 are located to have a high volume rate at a center of the first active material layer 120 compared to that at an outer peripheral side thereof. Hereinafter, in the plan view of the battery 1200, a central region of the first active material layer 120 in which the metal oxide particles 402 are disposed to have a high volume rate is also called a central portion 502.

According to the structure described above, since the heat dissipation is improved in the central region (that is, at the central portion 502) of the first active material layer 120 at which heat generation is liable to occur, the characteristics and the reliability of the battery can be suppressed from being degraded. Hence, a highly reliable battery can be realized.

For example, in the plan view, the volume rate of the metal oxide particles 402 at the central portion 502 may be higher by greater than or equal to 5% than the volume rate of the metal oxide particles 402 in the region (that is, at the outer peripheral side) other than the central portion 502 of the first active material layer 120. That is, the difference in volume rate between the metal oxide particles 402 at the central portion 502 and the metal oxide particles 402 at the outer peripheral side of the first active material layer 120 may be greater than or equal to 5%. The difference in volume rate between the metal oxide particles 402 at the central portion 502 and the metal oxide particles 402 at the outer peripheral side of the first active material layer 120 may be less than or equal to 40%.

As the concentration of the metal oxide particles 402 at the central portion 502 is increased, the heat dissipation is improved. On the other hand, when the metal oxide particles 402 are contained excessively in the active material layer, a decrease in capacity and/or degradation in charge/discharge characteristics may adversely occur in some cases.

The first electrode 100 may be a positive electrode. That is, the first active material layer 120 may be a positive electrode active material layer.

In the plan view, upside and downside main surfaces of the central portion 502 of the first active material layer 120 at which the volume rate of the metal oxide particles 402 is high may be in contact with the first collector 110 and the solid electrolyte layer 300, respectively. The side surface of the central portion 502 is in contact with the surrounding first active material layer 120.

The central portion 502 may be not in contact with one of the first collector 110 and the solid electrolyte layer 300 or may be not in contact with both of them. In the case described above, the main surfaces of the central portion 502 are in contact with the first active material layer 120. That is, when the cross-section of the battery 1200 is observed, the volume rate of the metal oxide particles 402 may be higher inside than outside the first active material layer 120. Even in the case described above, the heat dissipation effect from the inside of the first active material layer 120 can be obtained.

The shape of the central portion 502 at which the volume rate of the metal oxide particles 402 is high may be rectangular in plan view. As other examples of the shape, a circular or a polygonal shape may be mentioned. Since the central portion 502 is provided so as to cover at least part of a portion which is liable to generate heat, the heat dissipation can be performed through the first collector 110 or the solid electrolyte layer 300.

The concentration of the metal oxide particles 402 may be increased from the center to the outer periphery of the first active material layer 120 continuously or in a stepwise manner.

The volume rates of the metal oxide particles 402 at the outer peripheral side and the central portion 502 of the first active material layer 120 in the plan view can be obtained in a manner such that area rates of the metal oxide particles 400 are obtained by a cross-sectional observation of the first active material layer 120 using a SEM image, and the values thus obtained are regarded as the volume rates. The cross-section of the first active material layer 120 used for the cross-sectional observation is, for example, an ion polished surface.

### (Fourth Embodiment)

Hereinafter, a battery of a fourth embodiment will be described. The items described in the above embodiments may be appropriately omitted.

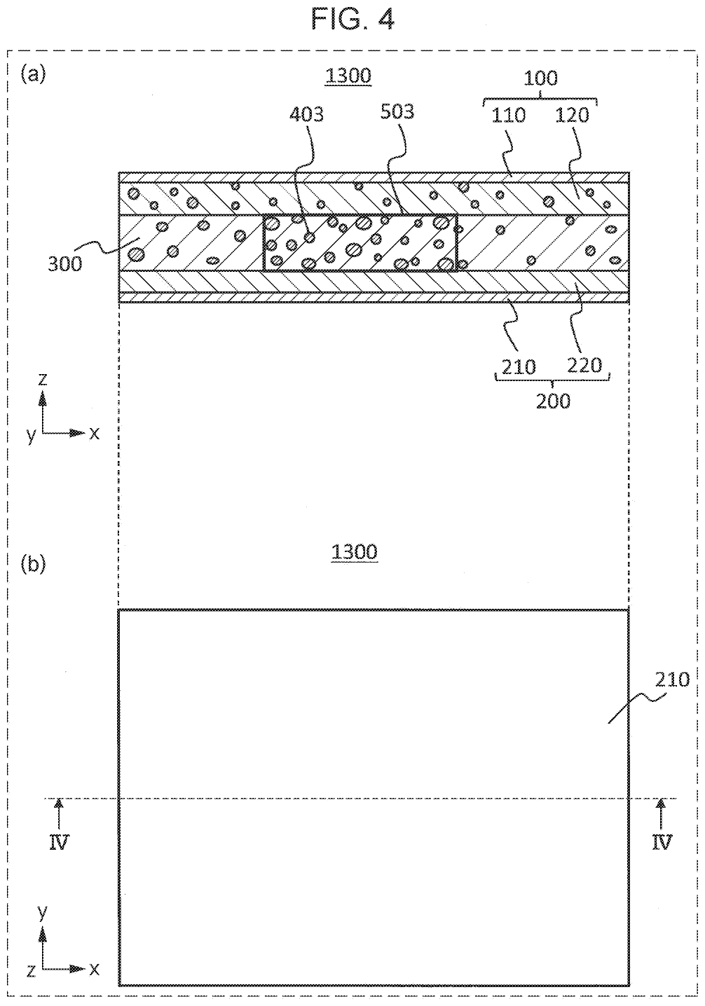

FIG. 4 illustrates a cross-sectional view and a plan view showing a schematic structure of a battery 1300 of the fourth embodiment.

FIG. 4(a) is a cross-sectional view of the battery 1300 of the fourth embodiment. FIG. 4(b) is a plan view of the battery 1300 of the fourth embodiment when viewed from a lower side along the z axis direction. FIG. 4(a) shows a cross-section cut along IV-IV line in FIG. 4(b).

As shown in FIG. 4, in the plan view of the battery 1300, metal oxide particles 403 are located to have a high volume rate at a center of the solid electrolyte layer 300 compared to that at an outer peripheral side thereof. Hereinafter, in the plan view of the battery 1300, a central region of the first active material layer 120 in which the metal oxide particles 403 are disposed to have a high volume rate is also called a central portion 503.

According to the structure described above, from the central region of the first active material layer 120 at which heat generation is liable to occur, the heat can be selectively transported and diffused by the central region (that is, by the central portion 503) of the solid electrolyte layer 300. Accordingly, the heat dissipation from the central region of the first active material layer 120 which may function as a heat source can be further improved. Hence, the characteristics and the reliability of the battery can be suppressed from being degraded.

For example, in the plan view, the volume rate of the metal oxide particles 403 at the central portion 503 may be higher by greater than or equal to 5% than the volume rate of the metal oxide particles 403 in the region (that is, at the outer peripheral side) other than the central portion 503 of the solid electrolyte layer 300. That is, the difference in volume rate of the metal oxide particles 403 between the central portion 503 and the outer peripheral side of the solid electrolyte layer 300 may be greater than or equal to 5%. The difference in volume rate of the metal oxide particles 403 between the central portion 503 and the outer peripheral side of the solid electrolyte layer 300 may be less than or equal to 40%.

As the concentration of the metal oxide particles 403 at the central portion 503 is increased, the heat dissipation is improved. On the other hand, when the metal oxide particles 403 are excessively contained in the solid electrolyte layer 300, the electric conductivity is decreased, and as a result, the charge/discharge characteristics of the battery may be degraded in some cases.

The first electrode 100 may be a positive electrode. That is, the first active material layer 120 may be a positive electrode active material layer.

The central portion 503 in the plan view at which the concentration of the metal oxide particles 403 is high may have a rectangular shape. As other examples of the shape, a circular or a polygonal shape may be mentioned. The central portion 503 may be disposed so as to be in contact with the active material layer which is liable to generate heat. For example, the central portion 503 may be disposed in contact with the first active material layer 120. The central portion 503 may also be disposed in contact with the first active material layer 120 and the second active material layer 220. Accordingly, the heat dissipation is likely to occur in the battery. As a result, a highly reliable battery can be realized.

The concentration of the metal oxide particles 403 may be increased from the center to the outer periphery of the solid electrolyte layer 300 continuously or in a stepwise manner.

The volume rate of the metal oxide particles 403 can be obtained by a cross-sectional observation of the solid electrolyte layer 300 using a SEM image. The cross-section is, for example, an ion polished surface.

### (Fifth Embodiment)

Hereinafter, a battery of a fifth embodiment will be described. The items described in the above embodiments may be appropriately omitted.

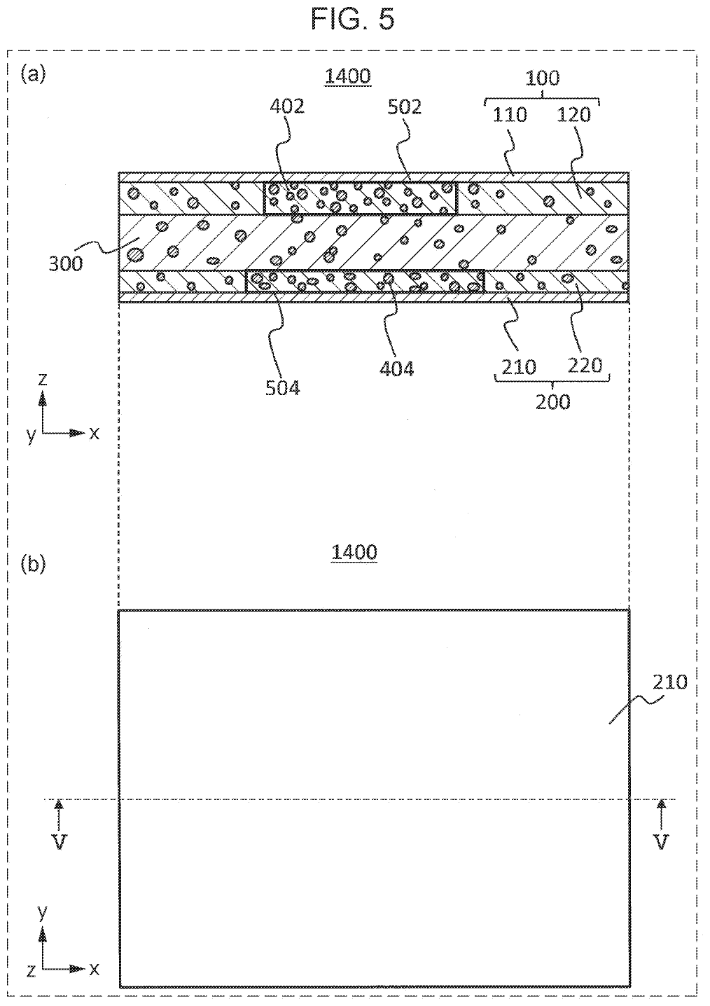

FIG. 5 illustrates a cross-sectional view and a plan view showing a schematic structure of a battery 1400 of the fifth embodiment.

FIG. 5(a) is a cross-sectional view of the battery 1400 of the fifth embodiment.

FIG. 5(b) is a plan view of the battery 1400 of the fifth embodiment when viewed from a lower side along the z axis direction. FIG. 5(a) shows a cross-section cut along a V-V line in FIG. 5(b).

As shown in FIG. 5, in the battery 1400, the second active material layer 220 encloses metal oxide particles 404. The battery 1400 shown in FIG. 5 has the structure in which in the battery 1200, the metal oxide particles 404 are further contained in the second active material layer 220. In the plan view, the metal oxide particles 404 are located to have a high volume rate at a center of the second active material layer 220 compared to that at an outer peripheral side thereof. Hereinafter, in the plan view of the battery 1400, a central region of the second active material layer 220 in which the metal oxide particles 404 are disposed to have a high volume rate is also called a central portion 504.

According to the structure described above, the heat dissipation of the central region (that is, the central portion 504) of the second active material layer 220 at which heat generation is liable to occur can be improved. In addition, when heat is generated in the central region of the first active material layer 120, the heat can be dissipated from the central portion 504 of the second active material layer 220 through the solid electrolyte layer 300.

In the battery 1400, as is the case of the battery 1200, the first active material layer 120 may or may not have a region (the central portion 502 of the battery 1200) having a high concentration of the metal oxide particles when viewed in plan. The battery 1400 may contain no metal oxide particles in the first active material layer 120.

The position and the shape of the central portion 504 of the second active material layer 220 and the concentration and the type of the metal oxide particles 404 may be different from those in the region (the central portion 502 of the battery 1200) of the first active material layer 120 at which the concentration of the metal oxide particles 402 is high. Accordingly, the amount of the active material can be changed, and the battery characteristics or the heat dissipation can be controlled. As a result, a highly reliable battery having more excellent battery characteristics can be realized.

The volume rate of the metal oxide particles 404 can be obtained by a cross-sectional observation of the second active material layer 220 using a SEM image. The cross-section is, for example, an ion polished surface.

### (Sixth Embodiment)

Hereinafter, a battery of a sixth embodiment will be described. The items described in the above embodiments may be appropriately omitted.

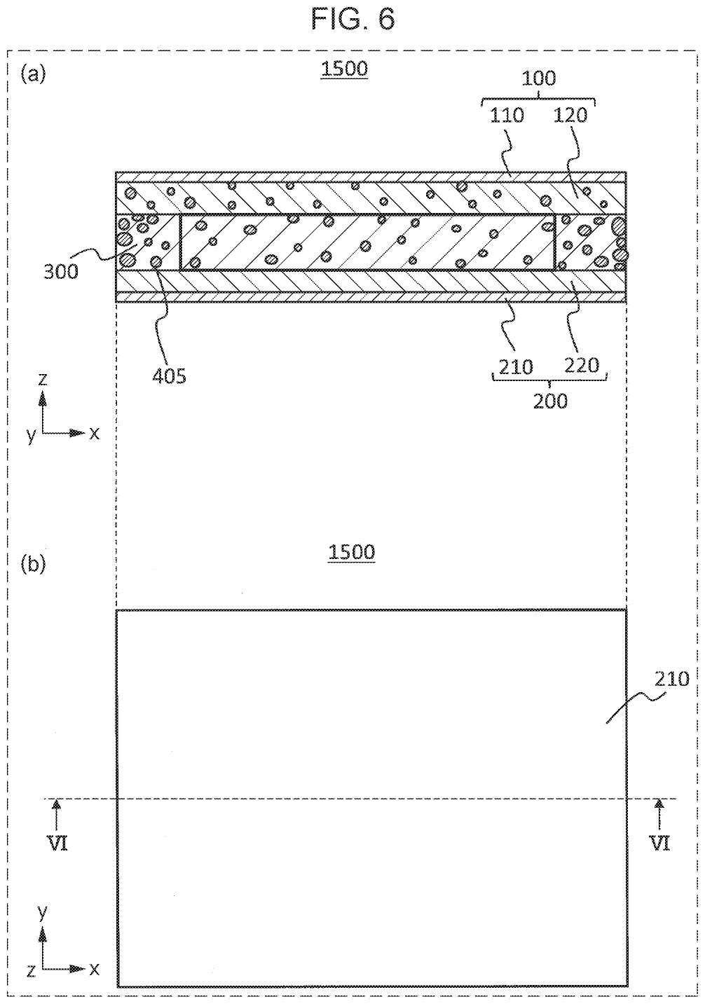

FIG. 6 illustrates a cross-sectional view and a plan view showing a schematic structure of a battery 1500 of the sixth embodiment.

FIG. 6(a) is a cross-sectional view of the battery 1500 of the sixth embodiment. FIG. 6(b) is a plan view of the battery 1500 of the sixth embodiment when viewed from a lower side along the z axis direction. FIG. 6(a) shows a cross-section cut along a VI-VI line in FIG. 6(b).

As shown in FIG. 6, in the plan view of the battery 1500, metal oxide particles 405 are located to have a high volume rate at an outer peripheral side of the solid electrolyte layer 300 compared to that at a center thereof.

According to the structure described above, the heat dissipation from the side surface of the solid electrolyte layer 300 can be improved. In addition, since the metal oxide particles 405 improves an insulation property of the side surface of the battery 1500, even when the active material falls by an impact or the like, the battery can be prevented from being short-circuited. Hence, while the heat dissipation is improved, a highly reliable battery can be realized.

For example, in the plan view, the volume rate of the metal oxide particles 405 at the outer peripheral side of the solid electrolyte layer 300 may be higher by greater than or equal to 5% than the volume rate of the metal oxide particles 405 at the center of the solid electrolyte layer 300. That is, the difference in volume rate of the metal oxide particles 405 between the center and the outer peripheral side of the solid electrolyte layer 300 may be greater than or equal to 5%. The difference in volume rate of the metal oxide particles 405 between the center and the outer peripheral side of the solid electrolyte layer 300 may be less than or equal to 40%.

The volume rate of the metal oxide particles 405 can be obtained by a cross-sectional observation of the solid electrolyte layer 300 using a SEM image. The cross-section is, for example, an ion polished surface.

### (Seventh Embodiment)

Hereinafter, a battery of a seventh embodiment will be described. The items described in the above embodiments may be appropriately omitted.

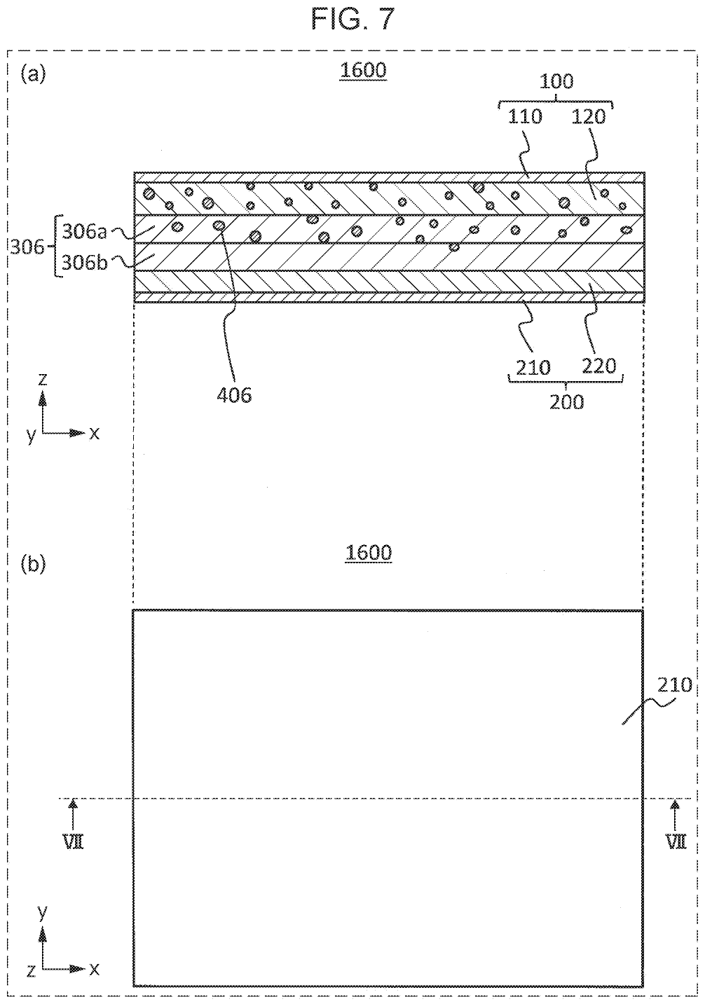

FIG. 7 illustrates a cross-sectional view and a plan view showing a schematic structure of a battery 1600 of the seventh embodiment.

FIG. 7(a) is a cross-sectional view of the battery 1600 of the seventh embodiment.

FIG. 7(b) is a plan view of the battery 1600 of the seventh embodiment when viewed from a lower side along the z axis direction. FIG. 7(a) shows a cross-section cut along a VII-VII line in FIG. 7(b).

As shown in FIG. 7, in the battery 1600, a solid electrolyte layer 306 includes a first solid electrolyte layer 306a and a second solid electrolyte layer 306b. The first solid electrolyte layer 306a is disposed between the first active material layer 120 and the second solid electrolyte layer 306b. The first solid electrolyte layer 306a encloses metal oxide particles 406. A volume rate of the metal oxide particles 406 in the first solid electrolyte layer 306a is higher than that of the metal oxide particles 406 in the second solid electrolyte layer 306b.

According to the structure described above, the heat dissipation can be performed on a main surface of the first active material layer 120. Hence, when a thermal shock is applied, there can be suppressed a peeling at a first interface (interface between the first active material layer 120 and the first solid electrolyte layer 306a) at which a stress is liable to be generated due to a non-equivalent state by a thermal cycle stress on the main surface of the first active material layer 120. As described above, a highly reliable battery having an excellent thermal shock resistance can be realized.

As shown in FIG. 7, in the battery 1600, the metal oxide particles 406 are also enclosed in the first active material layer 120.

The thickness of the first solid electrolyte layer 306a may be formed so as to have a thermal conductivity approximately equivalent to that of the first active material layer 120.

For example, the volume rate of the metal oxide particles 406 in the first solid electrolyte layer 306a may be higher by greater than or equal to 5% than the volume rate of the metal oxide particles 406 in the second solid electrolyte layer 306b. That is, the difference in volume rate of the metal oxide particles 406 between the first solid electrolyte layer 306a and the second solid electrolyte layer 306b may be greater than or equal to 5%. The difference in volume rate of the metal oxide particles 406 between the first solid electrolyte layer 306a and the second solid electrolyte layer 306b may be less than or equal to 40%.

The thickness of the first solid electrolyte layer 306a may be larger than the thickness of the first collector 110.

As shown in FIG. 7, in the battery 1600, the second solid electrolyte layer 306b may contain no metal oxide particles 406.

A solid electrolyte forming the first solid electrolyte layer 306a may be a material having a different composition from that of a solid electrolyte forming the second solid electrolyte layer 306b.

Accordingly, solid electrolytes suitable for respective materials of the positive electrode and the negative electrode may be used. For example, when the first electrode 100 is a positive electrode, in view of electrochemical stability, the first solid electrolyte layer 306a may contain a halide solid electrolyte, and the second solid electrolyte layer 306b may contain a sulfide-based solid electrolyte.

### (Eighth Embodiment)

Hereinafter, a battery of an eighth embodiment will be described. The items described in the above embodiments may be appropriately omitted.

The battery according to the eighth embodiment includes a first active material layer, a solid electrolyte layer, and a second active material layer in this order. At least one selected from the group consisting of the first active material layer and the second active material layer contains metal oxide particles. The first active material layer contains a first active material. The second active material layer contains a second active material. The metal oxide particles have a thermal conductivity higher than that of each of the first active material and the second active material and have no electron conductivity.

According to the structure described above, heat generated in the active material layer in charge/discharge operation can be diffused and dissipated from a heat generation portion by the metal oxide particles. As described above, since an increase in temperature of the battery in the operation can be suppressed, the battery characteristics can be suppressed from being degraded caused by repeated charge/discharge cycles. Hence, a highly reliable battery having excellent characteristics can be realized.

In the battery according to the eighth embodiment, the solid electrolyte layer may or may not contain metal oxide particles.

The thermal conductivities of the metal oxide particles, the first active material, and the second active material can be compared with each other by a method similar to that described in the first embodiment.

The first active material layer may contain the metal oxide particles.

The battery according to the eighth embodiment may further include a first collector and a second collector. That is, the battery according to the eighth embodiment may include the first collector, the first active material layer, the solid electrolyte layer, the second active material layer, and the second collector in this order. The first collector, the first active material layer, and the first active material may be a positive electrode collector, a positive electrode active material layer, and a positive electrode active material, respectively. In the case described above, the second collector, the second active material layer, and the second active material are a negative electrode collector, a negative electrode active material layer, and a negative electrode active material, respectively.

### [Method for Manufacturing Battery]

Hereinafter, one example of a method for manufacturing a battery of the present disclosure will be described.

As one example, a method for manufacturing the battery 1000 of the first embodiment will be described.

In the following description, the first electrode 100 is a positive electrode, and the second electrode 200 is a negative electrode. That is, the first active material layer 120 is a positive electrode active material layer, and the second active material layer 220 is a negative electrode active material layer.

First, pastes used for printing formation of the positive electrode active material layer and the negative electrode active material layer are formed.

As a solid electrolyte raw material used as a mixing agent for the positive electrode active material layer and the negative electrode active material layer, for example, a powdered halide solid electrolyte having an average particle diameter of approximately 3 μm is prepared. The halide solid electrolyte has an ion conductivity, for example, of 1×10⁻³ to 3×10⁻³ S/cm. As the halide solid electrolyte, for example, Li₃YCl₆ or Li₃YBr₆ is used.

As the positive electrode active material, for example, a powdered composite oxide, such as LiCoO₂, having an average particle diameter of approximately 3 μm is used.

As the metal oxide particles, for example, a powdered yttrium oxide having an average particle diameter of approximately 1 μm is used. As described above, the metal oxide particles may have a particle diameter smaller than the particle diameter of the materials for the solid electrolyte layer and the active material layer. Accordingly, the metal oxide particles are likely to be filled in voids between the active material particles or the solid electrolyte particles. In addition, since contact areas between the metal oxide particles and the active material particles or the solid electrolyte particles are increased, heat is likely to be diffused and dissipated.

Since the powdered positive electrode active material, the powdered solid electrolyte, and the powdered yttrium oxide are dispersed in an organic solvent or the like, a positive electrode active material-layer paste can be formed in an inert gas atmosphere.

The positive electrode active material-layer paste may be formed, for example, by a three-roll mill.

In addition, when metal oxide particles having a large particle diameter across the interface between the layers of the battery are disposed, for example, metal oxide particles having a particle diameter larger than the thickness of the solid electrolyte layer are contained and dispersed in a solid electrolyte-layer paste.

As the negative electrode active material, for example, a powdered natural graphite having an average particle diameter of approximately 4 μm is used.

Since the powdered negative electrode active material and the powdered solid electrolyte described above are dispersed in an organic solvent or the like, a negative electrode active material-layer paste is formed.

Next, as the positive electrode collector and the negative electrode collector, for example, copper foil having a thickness of approximately greater than or equal to 10 μm and less than or equal to 15 μm is prepared. By a screen printing method, the positive electrode active material-layer paste and the negative electrode active material-layer paste are each printed on one surface of the corresponding copper foil to have a predetermined shape and a thickness of approximately greater than or equal to 50 μm and less than or equal to 100 μm. The positive electrode active material-layer paste and the negative electrode active material-layer paste are dried at a temperature of higher than or equal to 80° C. and lower than or equal to 130° C. As described above, the positive electrode active material layer and the negative electrode active material layer are formed on the positive electrode collector and the negative electrode collector, respectively. The positive electrode and the negative electrode each have a thickness of greater than or equal to 30 μm and less than or equal to 60 μm.

Subsequently, the powdered solid electrolyte and the powdered yttrium oxide described above are dispersed in an organic solvent or the like, so that the solid electrolyte-layer paste is formed. The solid electrolyte-layer paste described above is printed on each of the positive electrode and the negative electrode using a metal mask to have a thickness, for example, of approximately 100 μm. The positive electrode and the negative electrode on each of which the solid electrolyte-layer paste is printed are dried at a temperature of higher than or equal to 80° C. and lower than or equal to 130° C. As described above, the metal oxide particles are formed in the solid electrolyte layer and the positive electrode active material layer.

Next, the solid electrolyte formed on the positive electrode and the solid electrolyte formed on the negative electrode are laminated so as to be in contact with each other. The laminate thus formed is placed in a dice mold having a rectangular outer shape.

Subsequently, between a pressure mold punch and the laminate, an elastic sheet having a thickness of 70 μm and an elastic modulus of approximately 5×10⁶ Pa is inserted.

By the structure as described above, the pressure is applied to the laminate through the elastic sheet. Next, while the pressure mold is heated at 50° C., a pressure of 300 MPa is applied for 90 seconds. Accordingly, a laminate is obtained in which the positive electrode collector, the positive electrode active material layer, the solid electrolyte layer, the negative electrode active material layer, and the negative electrode collector are laminated to each other. The positive electrode active material layer and the solid electrolyte layer contain the metal oxide particles which are yttrium oxide.

In the manufacturing process described above, although being enclosed in the solid electrolyte layer containing a halide solid electrolyte, yttrium oxide is not sulfurized, and hence, a high thermal conductivity can be maintained. The presence of a suflurized material can be evaluated by a composition analysis method, such as EPMA, performed on a polished cross-section of the battery. For example, the polished cross-section is a formed by ion polishing.

The method for manufacturing a battery and the order of the steps thereof are not limited to those described above.

In the manufacturing method described above, although the case in which the positive electrode active material-layer paste, the negative electrode active material-layer paste, and the solid electrolyte-layer paste are applied by printing is described by way of example, the method is not limited thereto. As a printing method, for example, a doctor blade method, a calendar method, a spin coating method, a dip coating method, an ink jet method, an offset method, a die coating method, or a spray method may be used.

Heretofore, although the battery of the present disclosure has been described with reference to the embodiments, the present disclosure is not limited to those embodiments.

As long as not departing from the scope of the present disclosure, embodiments including various types of modifications made by a person skilled in the art and other embodiments formed by combination using at least one constituent element of the embodiments are also included in the present disclosure.

The battery according to the present disclosure may be used as a secondary battery, such as a solid-state lithium ion battery, to be used for various types of electronic devices, automobiles, or the like.

What is claimed is:

1. A battery comprising
a first active material layer,
a solid electrolyte layer, and
a second active material layer in this order,
wherein at least one selected from the group consisting of the first active material layer and the second active material layer contains metal oxide particles,
the solid electrolyte layer contains metal oxide particles,
the first active material layer contains a first active material,
the second active material layer contains a second active material, and
the metal oxide particles have a thermal conductivity higher than that of each of the first active material and the second active material.

2. The battery according to claim 1,
wherein the metal oxide particles includes at least one selected from the group consisting of first metal oxide particles located at a first interface between the solid electrolyte layer and the first active material layer and second metal oxide particles located at a second interface between the solid electrolyte layer and the second active material layer.

3. The battery according to claim 2,
wherein the metal oxide particles includes the first metal oxide particles and the second metal oxide particles.

4. The battery according to claim 1,
wherein the metal oxide particles are dispersed in the solid electrolyte layer.

5. The battery according to claim 1,
wherein when the battery is viewed in plan, the metal oxide particles are located to have a high volume rate at a center of the solid electrolyte layer compared to that at an outer peripheral side thereof.

6. The battery according to claim 1,
wherein the metal oxide particles are in contact with a side surface of the solid electrolyte layer.

7. The battery according to claim 1,
wherein at least one selected from the group consisting of the first active material layer and the second active material layer contains the metal oxide particles, and
the metal oxide particles in the solid electrolyte layer have a high volume rate compared to that of the metal oxide particles in the first active material layer or the second active material layer.

8. A battery comprising
a first active material layer,
a solid electrolyte layer, and
a second active material layer in this order,
wherein at least one selected from the group consisting of the first active material layer and the second active material layer contains metal oxide particles,
the first active material layer contains a first active material,
the second active material layer contains a second active material, and
the metal oxide particles have a thermal conductivity higher than that of each of the first active material and the second active material and have no electron conductivity.

9. The battery according to claim 1,
wherein the metal oxide particles includes particles having a particle diameter of greater than or equal to 1 μm and less than or equal to 100 μm.

10. The battery according to claim 9,
wherein the metal oxide particles includes particles having a particle diameter of greater than or equal to 1 μm and less than or equal to 10 μm.

11. The battery according to claim 1,
wherein the metal oxide particles have an insulation property.

12. The battery according to claim 1,
wherein the metal oxide particles include at least one selected from the group consisting of Y, Al, and Mg.

13. The battery according to claim 12,
wherein the metal oxide particles include Y.

14. The battery according to claim 13,
wherein the metal oxide particles have an oxygen deficiency.

15. The battery according to claim 1, further comprising:
a first collector; and
a second collector,
wherein the first collector, the first active material layer, the solid electrolyte layer, the second active material layer, and the second collector are disposed in this order, and
the metal oxide particles are harder than the first collector, a solid electrolyte contained in the solid electrolyte layer, and the second collector.

16. The battery according to claim 1,
wherein the solid electrolyte layer contains a halide solid electrolyte.

17. The battery according to claim 1,
wherein the first active material layer contains the metal oxide particles, and
when the battery is viewed in plan, the metal oxide particles are located to have a high volume rate at a center of the first active material layer compared to that at an outer peripheral side thereof.

18. The battery according to claim 1,
wherein the second active material layer contains the metal oxide particles, and
when the battery is viewed in plan, the metal oxide particles are located to have a high volume rate at a center of the second active material layer compared to that at an outer peripheral side thereof.

19. The battery according to claim 1,
wherein the first active material layer and the second active material layer contain the metal oxide particles, and
the metal oxide particles in the first active material layer have a high volume rate compared to that of the metal oxide particles in the second active material layer.
